(19) United States
(12) Patent Application Publication
(10) Pub. No.: US 2015/0048563 A1
(43) Pub. Date: Feb. 19, 2015

(54) Portable Workbench

(71) Applicant: Black & Decker Inc., Newark, DE (US)

(72) Inventors: Ross A. Billings, Reisterstown, MD (US); Warren A. Ceroll, Owings Mills, MD (US); Peter Chaikowsky, Forest Hill, MD (US); Floyd E. Moreland, York, PA (US); Christian V. Elder, Baltimore, MD (US)

(21) Appl. No.: 14/319,558

(22) Filed: Jun. 30, 2014

Related U.S. Application Data
(60) Provisional application No. 61/865,300, filed on Aug. 13, 2013.

(51) Int. Cl. B25H 1/04; B25H 1/06

(52) U.S. Cl. CPC B25H 1/04; B25H 1/06
USPC 269/17

(57) ABSTRACT

A portable work bench may include a body, legs connected to the body for supporting the body, the legs being movable between an open position and a closed position, at least one wheel connected to the body, and a handle connected to the body. A surface of the handle and a surface of the wheel define a plane. The workbench does not have any portions that extend below the plane when the legs are in the closed position.

### CROSS-REFERENCE TO RELATED APPLICATION

This application derives priority from U.S. Patent Application No. 61/865,300, filed on Aug. 13, 2013, now pending, which is hereby incorporated in whole by reference.

### FIELD

This invention relates generally to workbenches and more particularly to a portable workbench that can support a power tool.

### BACKGROUND

It is common in the construction industry for users to bring their power tools to the work site. Thus, the users require a work surface at the work site to support the power tools for use. Preferably the work surface is at a certain height so that the user can comfortably use the power tool. In addition, the work surface should also be sufficiently portable to be easily moved around a work site.

In the past, users have disposed their power tools on sheets of wood which are in turn supported by two or more sawhorses. This arrangement, however, lacks the strength and stability for efficient operation, as well as being difficult to set up and move around the work site.

### SUMMARY

In accordance with the present invention, an improved portable work bench is employed. The workbench may include a body, legs connected to the body for supporting the body, the legs being movable between an open position and a closed position, at least one wheel connected to the body, and a handle connected to the body. A surface of the handle and a surface of the wheel define a plane. The workbench does not have any portions that extend below the plane when the legs are in the closed position.

Additional features and benefits of the present invention are described, and will be apparent from, the accompanying drawings and the detailed description below.

### BRIEF DESCRIPTION OF THE DRAWINGS

The accompanying drawings illustrate preferred embodiments of the invention according to the practical application of the principles thereof, and in which:

FIG. 1 is a perspective view of a portable workbench of the present invention;

FIG. 2 is a perspective view of the workbench of FIG. 1 in an expanded mode;

FIG. 3 illustrates a method of loading the workbench unto a vehicle along four positions, where FIG. 3A show the first and second positions (in solid and broken lines, respectively) and FIG. 3B show the third and fourth positions (in solid and broken lines, respectively); and

FIG. 4 is a cross-sectional view of a leg locking mechanism along line X-X of FIG. 1.

### DETAILED DESCRIPTION

The invention is now described with reference to the accompanying figures, wherein like numerals designate like parts. Referring to FIG. 1, a portable work bench 10 of the present invention is designed to carry a table saw 100 and/or a workpiece (not shown). However, persons skilled in the art will recognize that the work bench 10 can support any power tool, such as a sliding compound miter saw, a drill press, a chop saw, etc., any hand tools, or anything else that may need to be supported.

The work bench 10 has a structural body 11 for supporting table saw 100. Preferably structural body 11 is a tube (or multiple tubes) shaped as a closed loop. Table saw 100 can be bolted directly unto structural body 11.

In addition, the work bench 10 may have leg assemblies 30 for supporting the structural body 11 (and thus the table saw 100 and/or workpiece). Referring to FIGS. 1 and 3-4, the leg assemblies 30 may include a leg 31 pivotally connected to the body 11 via brackets 32. Preferably, leg 31 is made of metal, such as extruded aluminum. The cross-section of leg 31 may be round or ob-round (with two opposing substantially flat sides). Leg 31 may have an end 31R, which may be made of an elastomeric material, a plastic or rubber. Preferably, the end 31R is made of a material that prevents slippage of the leg 31 along a floor or other supporting surface.

Bracket 32 may wrap around the end of body 11. Preferably, bracket 32 is made of metal, such as sheet steel. Preferably, bracket 32 is attached to body 11 via screws, as disclosed in U.S. Pat. No. 7,036,540, which is hereby incorporated by reference.

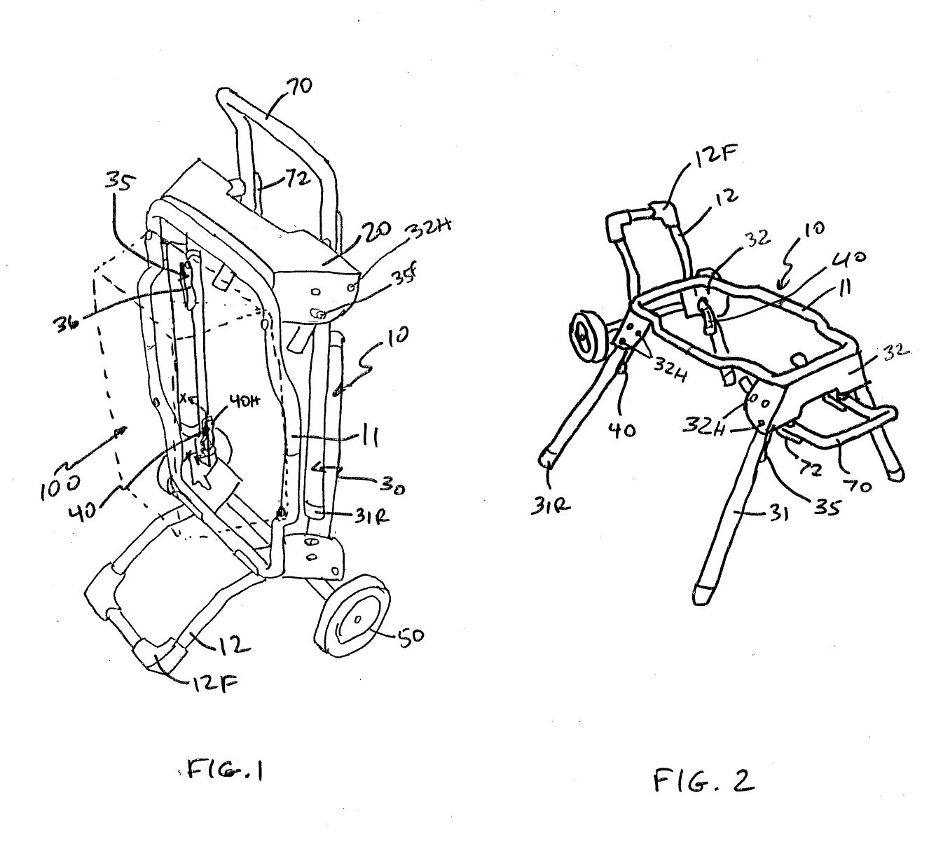

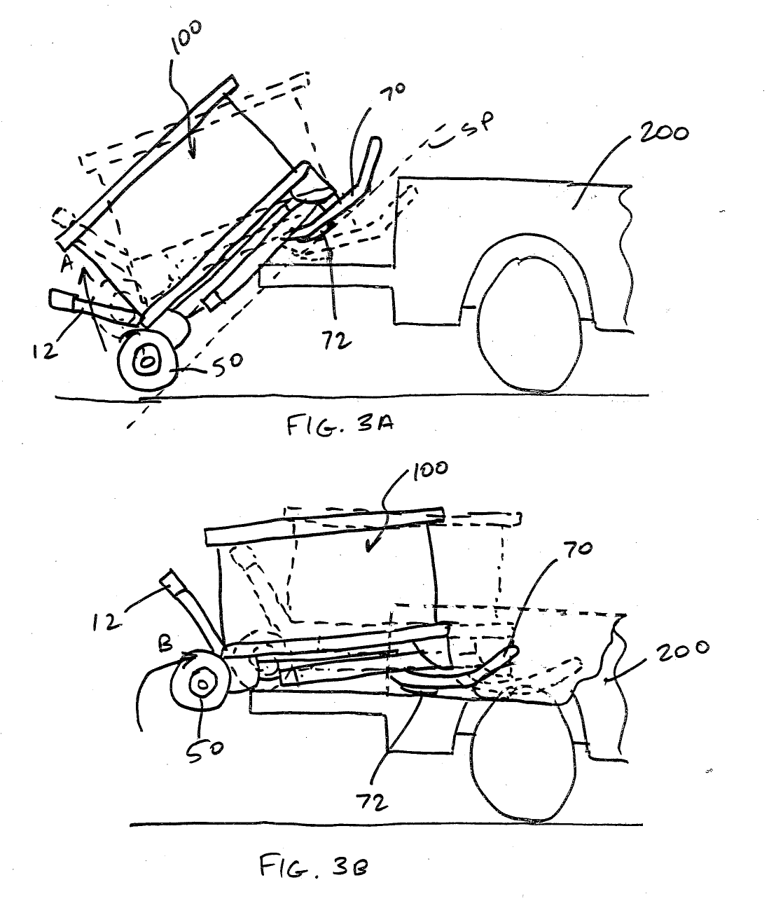

Preferably each leg 31 can be rotated between a closed position (such as that shown in FIG. 1) and an open position (such as that shown in FIG. 2). As discussed further below, a detent mechanism may be used to maintain the leg 31 in the desired position.

Portable workbench 10 may have at least one wheel assembly 50 and preferably two wheel assemblies 50. As shown in FIGS. 1 and 3, wheel assemblies 50 are preferably disposed at the end or near the end of body 11. Persons skilled in the art are referred to US Publication No. 20040250903, which is wholly incorporated by reference, for further information on wheel assembly 50.

It is preferable to attach a supplemental support 12 to bracket 32 and/or body 11 at the same end of body 11 that has wheel assemblies 50. Supplemental support 12 may be a tube attached bracket 32. Supplemental support 12 may also have rubberized feet 12F provided on the tube. In this manner, the workbench 10 can be closed and stored like a hand truck or dolly.

It is preferable to provide a handle assembly 70 at the other end of body 11 (that does not have wheel assemblies 50). As shown in FIG. 1, when in the closed position, workbench 10 can be pushed around like a hand truck or dolly.

Preferably handle assembly 70 is a tube attached bracket 32. Handle assembly 70 may have pads 72 disposed thereunder. Pads 72 provide a low friction surface that can slide along any surface. Persons skilled in the art shall recognize that a surface of pads 72 and a surface of wheel assemblies 50 define a plane SP (shown in FIG. 3A), and that no part of workbench 10 extend beyond such plane SP when workbench 10 is in the closed position.

With such arrangement, a user can easily load workbench 10 into a vehicle 200. Referring to FIG. 3A, the user can lean workbench 10 against vehicle 200 (such position of workbench 10 is shown in solid lines in FIG. 3A). The user can then lift workbench 10 by supplemental support 12 along the direction of arrow A, moving pads 72 into contact with vehicle 200 (such position of workbench 10 is shown in broken lines in FIG. 3A). The user can then push workbench 10 via supplemental support 12 along the direction of arrow B so that pads 72 slide along vehicle 200 (such position of workbench 10 is shown in solid lines in FIG. 3B) until wheel assemblies 50 are supported by vehicle 200 (such position of workbench 10 is shown in broken lines in FIG. 3B).

As mentioned above, it is preferable to provide each leg assembly 30 with a detent mechanism 35 to maintain the leg 31 in the open and closed positions. Different detent mechanisms 35 may be found in U.S. Pat. Nos. 4,605,099 and 5,592,981, which are hereby incorporated by reference.

Preferably, detent mechanism 35 includes a detent pin 35P, which engages a hole 32H in bracket 32. Detent pin 35P may extend through leg 31 and lever arm 36. For further information on detent mechanism 35, persons skilled in the art are referred to US Patent Publication No. 2008/01966632, hereby incorporated by reference. Persons skilled in the art are also referred to U.S. Pat. Nos. 601,613, 691,050, 4,954,008, and 5,421,272, which are hereby incorporated by reference, for further information on similar detent mechanisms.

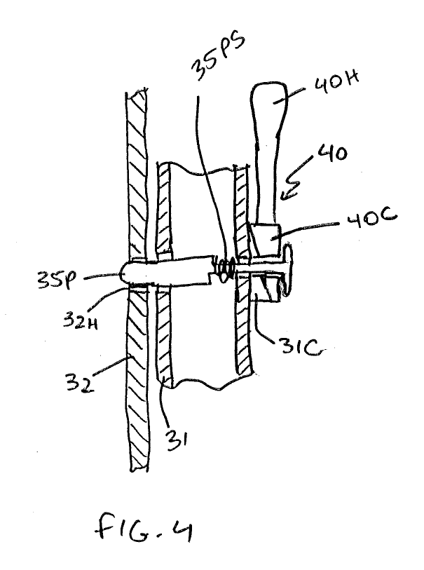

Alternatively, detent mechanism 35 may be provided solely on the legs 31 closest to handle assembly 70, as these are closer to the user's hands when workbench 10 is in the closed position of FIG. 1. Referring to FIG. 4, detent mechanism 40 may be provided on the legs 31 closest to wheel assemblies 50. Detent mechanism 40 can be preferably actuated by the user's foot.

Detent mechanism 40 may include a cam 31C on leg 31, a cam 40C contacting cam 31 C, a handle 40H for rotating cam 40C relative to cam 31C, and a detent pin 35P extending through leg 31 and cams 31C, 40C. A spring 35PS preferably biases detent pin 35P to engage a hole 3211 in bracket 32. When the user rotates handle 40H, cam 40C is rotated relative to cam 31C, moving detent pin 35P out of engagement with hole 32H, allowing leg 31 to be rotated relative to bracket 32.

Persons skilled in the art will recognize that the handle 40H (and thus cam 40C) can be rotated both in the clockwise and counter-clockwise directions to move detent pin 35P out of engagement with hole 32H. Persons skilled in the art should also recognize that, once the detent pin 35P is out of engagement with hole 32H, the user can move leg 31 by just putting pressure on handle 40H.

Once all four legs 31 are locked in the open position, the user can rotate workbench 10 about the ends 31R of legs 31 closest to the floor. The user can use the legs 31 farthest from the floor as handles to rotate workbench 10 until workbench 10 is in the position shown in FIG. 2. Preferably ends 31R are curved to further facilitate such rotational movement.

Persons skilled in the art may recognize other additions or alternatives to the means disclosed herein. However, all these additions and/or alterations are considered to be equivalents of the present invention.

What is claimed is:

1: A portable work bench comprising:
a body;
legs connected to the body for supporting the body, the legs being movable between an open position and a closed position;
at least one wheel connected to the body; and
a handle connected to the body;
a surface of the handle and a surface of the wheel define a plane, and the work bench not having any portions that extend below the plane when the legs are in the closed position.

2: The portable work bench of claim 1, wherein the handle has a pad on which the work bench may be slid on.

3: The portable work bench of claim 1, wherein at least one of the legs is maintained in at least one of the open position and closed position by a detent mechanism.

4: The portable work bench of claim 3, wherein the detent mechanism comprises a detent pin engageable to a hole in the body, and a rotatable handle for moving the pin, the rotatable handle being shaped so as to be movable by a user's foot.
